(19) United States
(12) Patent Application Publication
(10) Pub. No.: US 2026/0100448 A1
(43) Pub. Date: Apr. 9, 2026

(54) BATTERY PACK

(71) Applicant: HONDA MOTOR CO., LTD., Tokyo (JP)

(72) Inventors: Kazuto Yamane, Tokyo (JP); Ayako Akaba, Tokyo (JP)

(73) Assignee: HONDA MOTOR CO., LTD., Tokyo (JP)

(21) Appl. No.: 19/350,771

(22) Filed: Oct. 6, 2025

(30) Foreign Application Priority Data
Oct. 7, 2024 (JP) 2024-175608

(51) Int. Cl. H01M 10/6568; B60L 50/64; H01M 10/613; H01M 10/625; H01M 10/6551; H01M 50/204

(52) U.S. Cl. CPC H01M 10/6568; B60L 50/64; H01M 10/613; H01M 10/625; H01M 10/6551; H01M 50/204; H01M 2220/20

(57) ABSTRACT

A battery pack has a plurality of battery cells, a battery case accommodating the battery cells, and a water jacket provided below the battery cells and having a flow path configured to allow a refrigerant for adjusting a temperature of the battery cells to flow therethrough. The water jacket has a plurality of corner regions provided in the flow path. At least one of the corner regions is provided with a fin extending along a flow direction of the refrigerant.

### CROSS-REFERENCE TO RELATED APPLICATIONS

This application is based on and claims priority under 35 USC 119 from Japanese Patent Application No. 2024-175608 filed on Oct. 7, 2024, the entire content of which is incorporated herein by reference.

### TECHNICAL FIELD

The present invention relates to a battery pack mounted on an electric vehicle or the like.

### BACKGROUND ART

In recent years, researches and developments have been conducted on a secondary battery which contributes to improvement in energy efficiency in order to allow more people to have access to affordable, reliable, sustainable and advanced energy.

A high-output and large-capacity battery is mounted on an electric vehicle such as a battery type electric automobile, a plug-in hybrid vehicle, or a fuel cell vehicle. Since the battery mounted on the electric vehicle generates a large amount of heat during charging and discharging, a cooling mechanism for cooling the battery is provided in view of safety and prevention of battery deterioration.

For example, JP2020-088109A discloses a cooling device provided below a heating element such as a battery or an electronic component. The cooling device includes a metal cooling panel for cooling the heating element, and a resin flow path that is joined to the metal cooling panel and through which a refrigerant flows.

Since the resin flow path described in JP2020-088109A has a meandering flow path structure, stagnation of the refrigerant flow may occur in the flow path. The cooling efficiency of the heating element may decrease due to the occurrence of stagnation.

### SUMMARY OF INVENTION

An object of the present disclosure is to provide a battery pack capable of preventing occurrence of stagnation in a flow path of a water jacket.

A first aspect of the present disclosure is to a battery pack having:
a plurality of battery cells;
a battery case accommodating the battery cells; and
a water jacket provided below the battery cells and having a flow path configured to allow a refrigerant for adjusting a temperature of the battery cells to flow therethrough, in which
the water jacket has a plurality of corner regions provided in the flow path, and
at least one of the corner regions is provided with a fin extending along a flow direction of the refrigerant.

A second aspect of the present disclosure is to a battery pack having:
a plurality of battery cells;
a battery case accommodating the battery cells; and
a water jacket provided below the battery cells and having a flow path configured to allow a refrigerant for adjusting a temperature of the battery cells to flow therethrough, in which
the water jacket has a confluence where at least two flow paths merge, and
the confluence is provided with a fin extending along a flow direction of the refrigerant.

According to the aspects of the present disclosure, the occurrence of stagnation in the flow path of the water jacket can be prevented.

### BRIEF DESCRIPTION OF DRAWINGS

Exemplary embodiment(s) of the present invention will be described in detail based on the following figures, wherein:

FIG. 1 is a perspective view of a battery pack 1 according to a first embodiment, illustrating a state in which a case cover 12 is removed from a case body 11;

FIG. 2 is an exploded perspective view of the battery pack 1 according to the first embodiment;

FIG. 3 is a top view of a plurality of battery modules 30 accommodated in the case body 11;

FIG. 4 is a front view of a battery cell 31;

FIG. 5 is a top view of a water jacket 50;

FIG. 6 illustrates a flow path of a refrigerant in the water jacket 50;

FIG. 7 is an enlarged top view of a branch 56;

FIG. 8 is an enlarged top view of a corner region 66 at a rear end of a main channel 60;

FIG. 9 is a top view of a water jacket 50 according to a modification;

FIG. 10 is a perspective view of a battery pack 2 according to a second embodiment, illustrating a state in which a case cover 12 is removed from a case body 11;

FIG. 11 is an exploded perspective view of the battery pack 2;

FIG. 12 is a perspective view of an upper-stage case body 20, the water jacket 50, and an upper-stage water jacket 80;

FIG. 13 illustrates flow paths of refrigerants in the water jacket 50 and the upper-stage water jacket 80;

FIG. 14 is an enlarged perspective view of a portion surrounded by a two-dot chain line in FIG. 13;

FIG. 15 is a cross-sectional view of a communication flow path 85 that allows the water jacket 50 to communicate with the upper-stage water jacket 80;

FIG. 16A is a perspective view of an upper end of a pipe member 86 provided with a rubber mount 91; and

FIG. 16B is a cross-sectional view of the upper end of a pipe member 86.

### DESCRIPTION OF EMBODIMENTS

Hereinafter, embodiments of a battery pack of the present invention will be described with reference to the accompanying drawings. The drawings are viewed from directions of reference numerals. In the present specification and the like, in order to simplify and clarify the description, in the drawings, a front side of a vehicle is shown as Fr, a rear side is shown as Rr, a left side is shown as L, a right side is shown as R, an upper side is shown as U, and a lower side is shown as D.

### First Embodiment

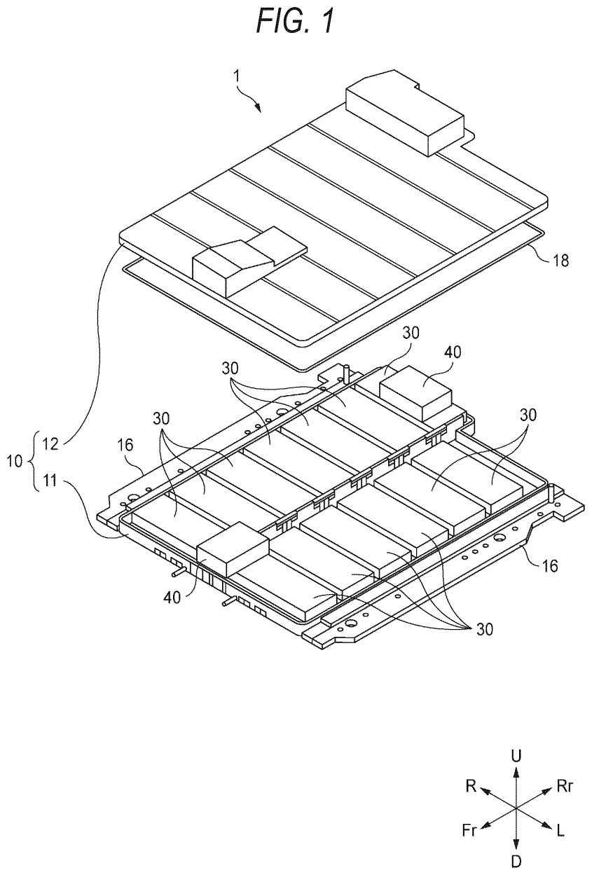

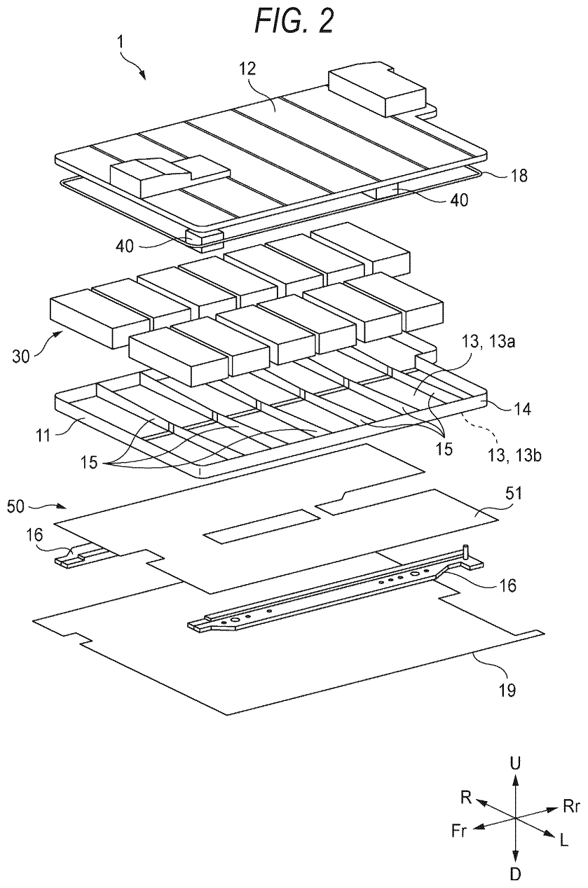

FIG. 1 is a perspective view of a battery pack 1 according to a first embodiment, illustrating a state in which a case cover 12 is removed from a case body 11. FIG. 2 is an exploded perspective view of the battery pack 1 according to the first embodiment.

The battery pack 1 is attached to an electric vehicle such as a battery type electric automobile, a plug-in hybrid vehicle, or a fuel cell vehicle, and stores power to be supplied to a motor or the like serving as a drive source of the electric vehicle. The battery pack 1 is attached under a floor of the electric vehicle.

The battery pack 1 includes a battery case 10 including the case body 11 and the case cover 12, a plurality of battery modules 30 accommodated in the battery case 10, an electric connection box 40 accommodated in the battery case 10 and having various electrical components installed therein, a water jacket 50 provided below the battery modules 30 and through which a refrigerant for adjusting a temperature of the battery modules 30 flows, and an undercover 19 formed of a heat insulating material and covering the battery case 10 and the water jacket 50 from below.

The case body 11 of the battery case 10 includes a bottom portion 13 and a side wall 14 surrounding the bottom portion 13, and is formed in a tray shape. The case cover 12 covers the case body 11, in which the battery modules 30, the electric connection box 40, and the like are accommodated, from above via a sealing material 18 to seal an inside of the battery pack 1. The case body 11 is provided with a plurality of cross members 15 extending in a left-right direction.

The case body 11 is formed of, for example, an aluminum alloy containing aluminum. Specifically, the case body 11 is formed by aluminum die casting. The aluminum die casting is formed by melting an aluminum alloy, filling the aluminum alloy into a metal mold at a high speed using a die casting machine, and then applying a high pressure. By forming the case body 11 from an aluminum alloy, a weight of the battery pack 1 can be reduced.

A pair of side frames 16 attached to both left and right ends are joined to the case body 11. The battery pack 1 is fixed to a vehicle body of the electric vehicle via the side frames 16.

Each battery module 30 has a substantially rectangular parallelepiped shape, and is accommodated in the case body 11 such that a longitudinal direction thereof is the left-right direction. In the first embodiment, thirteen battery modules 30 are placed on an upper surface 13a of the bottom portion 13 of the case body 11. Specifically, the battery modules 30 are aligned in two rows in the left-right direction. In a right row, seven battery modules 30 are aligned in a front-rear direction, and in a left row, six battery modules 30 are aligned in the front-rear direction. A cross member 15 is provided between battery modules 30 adjacent in the front-rear direction. The adjacent battery modules 30 are electrically connected to each other via a bus bar. The number and arrangement of the battery modules 30 can be set freely, and are not limited to the example shown in the FIG.

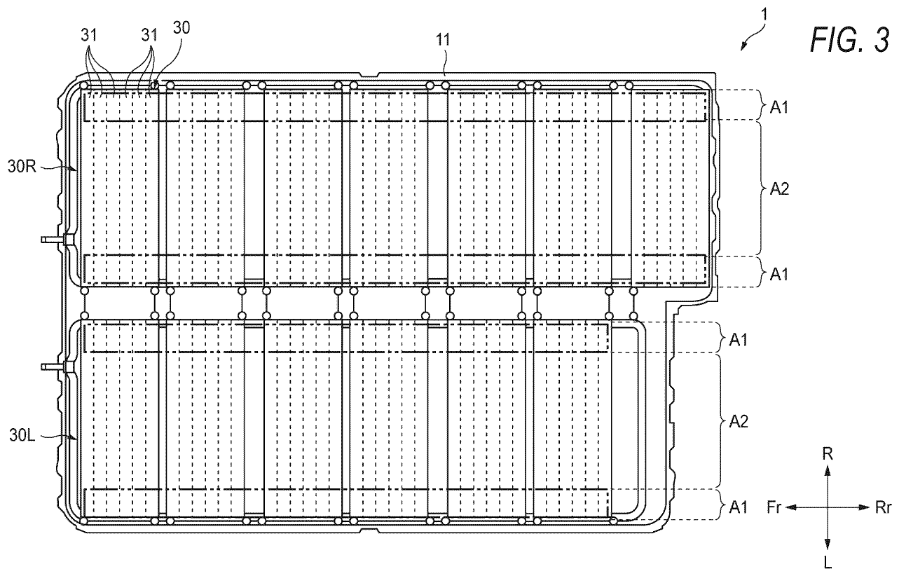

FIG. 3 is a top view of the plurality of battery modules 30 accommodated in the case body 11. Each battery module 30 is configured by stacking a plurality of battery cells 31 (broken lines). The battery cells 31 of each battery module 30 are stacked in the front-rear direction. Each of the battery cells 31 is, for example, a lithium ion battery or a nickel hydrogen battery.

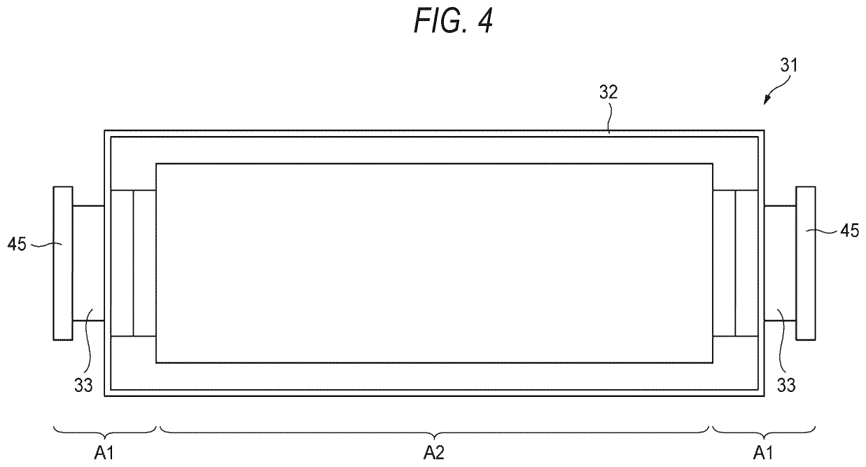

FIG. 4 is a front view of the battery cell 31. The battery cell 31 is, for example, a pouch-type cell. The battery cell 31 includes a positive electrode layer, a negative electrode layer, an electrolyte disposed between the positive electrode layer and the negative electrode layer, and an exterior body 32 that accommodates these components. Each of the positive electrode layer and the negative electrode layer is provided with a terminal 33 exposed from the exterior body 32. The plurality of battery cells 31 are electrically connected to each other via a bus bar 45 at the terminals 33. The battery cell 31 is not limited to a pouch-type cell and may be, for example, a rectangular cell. In addition, detailed illustration of the terminal 33 is omitted except for FIG. 4.

The battery cell 31 has an elongated shape, and the terminals 33 are provided at both ends in the longitudinal direction. When accommodated in the battery case 10, the battery cells 31 are arranged such that the longitudinal direction thereof is the left-right direction.

In the battery cell 31, in the longitudinal direction (left-right direction), a terminal region A1 provided with the terminal 33 is a region having a large heat generation amount, and a central region A2 between the terminals 33 is a region having a heat generation amount smaller than that of the terminal region A1. In FIG. 3, the terminal region A1 is indicated by a region surrounded by a two-dot chain line.

Referring back to FIGS. 1 and 2, two electric connection boxes 40 are provided near a front end and a rear end of the battery pack 1, respectively. The electric connection box 40 provided near the front end of the battery pack 1 is disposed to straddle upper portions of two battery modules 30 disposed in a front row. The electric connection box 40 provided near the rear end of the battery pack 1 is disposed above the battery module 30 disposed in the rearmost row of the right row. These two electric connection boxes 40 are connected by a high-voltage power line (for example, a cable or a bus bar) (not illustrated).

In addition to a power input/output circuit for the battery module 30, for example, a power input/output circuit for a drive unit mounted on an electric vehicle, a power input/output circuit for a charger, a power input/output circuit for auxiliary equipment, a circuit breaker that blocks energization of the battery pack 1 at the time of abnormality, and the like are mounted on the electric connection box 40.

The water jacket 50 is provided in a space defined between a cover plate 51 provided below the case body 11 and a lower surface 13b of the bottom portion 13 of the case body 11. A refrigerant (for example, cooling water) flows through the water jacket 50, and the water jacket 50 cools the battery module 30 by the flowing refrigerant. The water jacket 50 can also heat the battery module 30 by increasing a temperature of the flowing refrigerant in advance by a heater (not illustrated) or the like. In this way, the water jacket 50 adjusts a temperature of the battery module 30 by cooling or heating the battery module 30.

The cover plate 51 is joined to the lower surface 13b of the case body 11 by, for example, friction stir welding (FSW). More specifically, the lower surface 13b of the case body 11 and the cover plate 51 are each provided with irregularities. The lower surface 13b of the case body 11 is provided with a convex portion protruding toward the cover plate 51 and a concave portion recessed to a side opposite to the cover plate 51 with respect to the convex portion, and the cover plate 51 is provided with a convex portion protruding toward the case body 11 and a concave portion recessed to a side opposite to the case body 11 with respect to the convex portion. The friction stir welding is performed along the convex portions in a state in which the convex portions provided on the lower surface 13b of the case body 11 and the cover plate 51 are in contact with each other. Accordingly, a refrigerant flow path 55 is defined in the water jacket 50. Either the lower surface 13b of the case body 11 or the cover plate 51 may be a flat surface without any irregularities.

Since the water jacket 50 is provided on the lower surface 13b side of the bottom portion 13 of the case body 11, even if the water jacket 50 is damaged due to a collision of the electric vehicle or the like and the refrigerant leaks, the refrigerant can be prevented from contacting the battery module 30 accommodated in the case body 11.

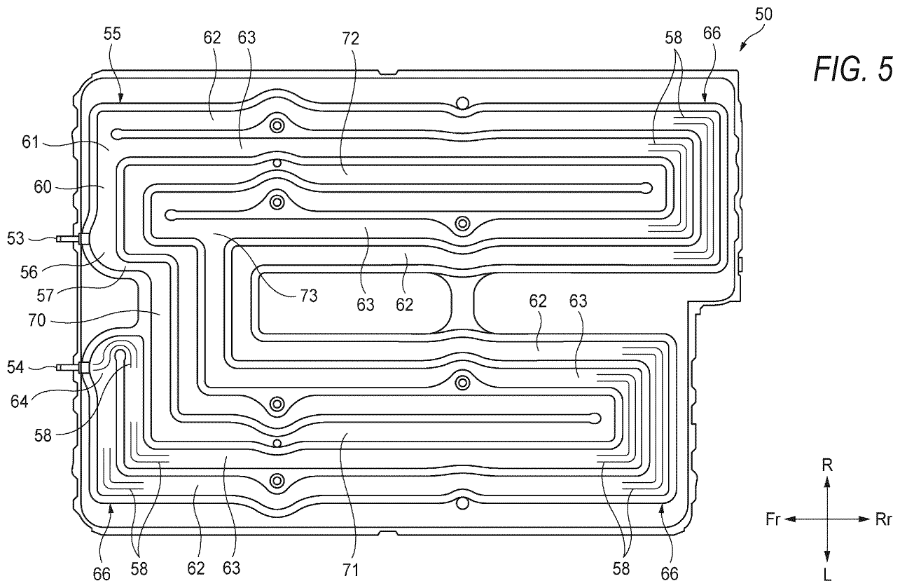

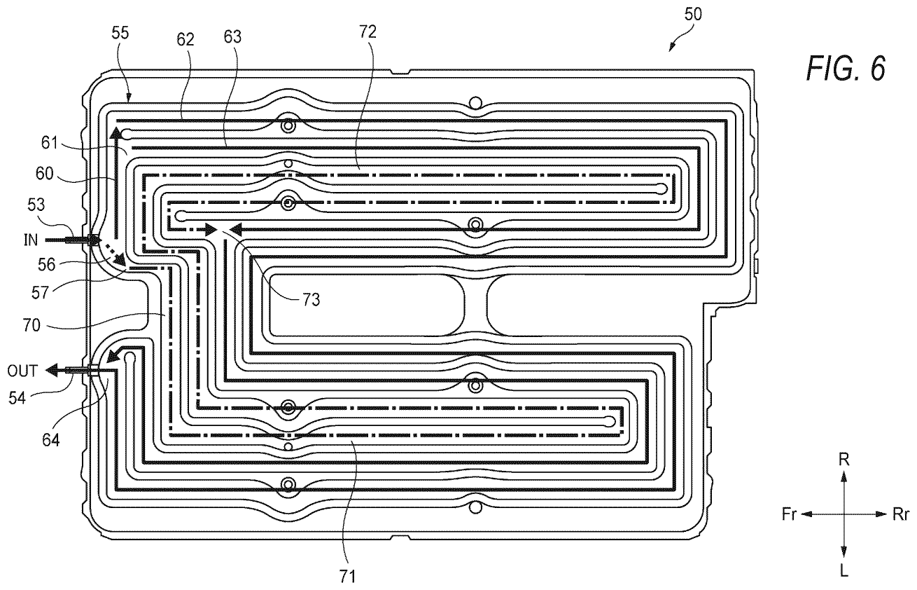

FIG. 5 is a top view of the water jacket 50. FIG. 6 illustrates a flow path of a refrigerant in the water jacket 50.

The water jacket 50 includes an inlet 53 and an outlet 54 provided at a central portion of a front end in the left-right direction, and the refrigerant flow path 55 through which the refrigerant flows. The inlet 53 is provided nearer to the right side in the central portion in the left-right direction, and the outlet 54 is provided nearer to the left side in the central portion in the left-right direction. The refrigerant is supplied from the inlet 53 to the water jacket 50, flows through the refrigerant flow path 55, and is discharged from the outlet 54 to the outside of the water jacket 50.

The water jacket 50 has a branch 56 that branches into two flow paths from the inlet 53. The branch 56 is provided near the inlet 53 in the refrigerant flow path 55. These two flow paths include a main channel 60 provided along the terminal region A1 of each battery module 30 and a branch channel 70 provided along the central region A2 of each battery module 30. The main channel 60 and the branch channel 70 constitute the refrigerant flow path 55 described above. In FIG. 6, the main channel 60 is indicated by a thick solid arrow, and the branch channel 70 is indicated by a thick dashed-dotted arrow.

The main channel 60 and the branch channel 70 of the water jacket 50 will be described in detail. In the following description, among the plurality of battery modules 30, the battery modules 30 provided on the right side of the battery case 10 are referred to as a right battery module group 30R, and the battery modules 30 provided on the left side of the battery case 10 are referred to as a left battery module group 30L (see FIG. 3).

The refrigerant flows through the main channel 60 in order of the right battery module group 30R and the left battery module group 30L. Specifically, the refrigerant flows through the main channel 60 in order of the terminal region A1 (from the front side to the rear side) on the right side of the right battery module group 30R, the terminal region A1 (from the rear side to the front side) on the left side of the right battery module group 30R, the terminal region A1 (from the front side to the rear side) on the right side of the left battery module group 30L, and the terminal region A1 (from the rear side to the front side) on the left side of the left battery module group 30L. That is, the main channel 60 forms a meandering flow path along the terminal regions A1 of the left battery module group 30L and the right battery module group 30R, and adjusts the temperature of the battery module 30.

The main channel 60 includes another branch 61 provided downstream of the branch 56 in a flow direction. The branch 61 is provided at a right front end of the water jacket 50, and further splits the main channel 60 into two flow paths. These two flow paths include an outer main channel 62 provided along an outer peripheral edge of the water jacket 50, and an inner main channel 63 provided along the outer main channel 62 at a position further inward than the outer main channel 62. The inner main channel 63 is provided along a position closer to the central region A2 between the terminal regions A1 of each battery module 30 than the outer main channel 62.

Since the main channel 60 branches into the outer main channel 62 and the inner main channel 63, even if an object collides with a bottom surface of the battery pack 1 and the outer main channel 62 (or the inner main channel 63) of the water jacket 50 is blocked, the flow of the refrigerant in the main channel 60 can be maintained through the inner main channel 63 (or the outer main channel 62).

The main channel 60 has a confluence 64 where the outer main channel 62 and the inner main channel 63 merge. The confluence 64 is provided near the outlet 54. The confluence 64 merges the refrigerant flowing through the outer main channel 62 and the inner main channel 63 and discharges the merged refrigerant from the outlet 54 to the outside of the water jacket 50.

The branch 61 and the confluence 64 are preferably provided upstream of the main channel 60 (a position close to the inlet 53) and downstream of the main channel 60 (a position close to the outlet 54), respectively. Accordingly, even when either the outer main channel 62 or the inner main channel 63 is blocked, an effect of maintaining the flow of the refrigerant in the main channel 60 is enhanced.

The branch channel 70 is provided along the central region A2 of each battery module 30, and is provided inward than the main channel 60 provided along the terminal region A1 of each battery module 30.

The refrigerant flows through the branch channel 70 in order of the left battery module group 30L and the right battery module group 30R. Specifically, the branch channel 70 includes a left branch channel 71 provided along the central region A2 of the left battery module group 30L, and a right branch channel 72 provided downstream of the left branch channel 71 in the flow direction and provided along the central region A2 of the right battery module group 30R. The left branch channel 71 causes the refrigerant branched from the branch 56 to flow rearward, and then turn back on a rear end side to flow forward. The left branch channel 71 and the right branch channel 72 communicate with each other on a front end side of the water jacket 50. The right branch channel 72 causes the refrigerant flowing from the left branch channel 71 to flow rearward, and then turn back on the rear end side to flow forward.

The branch channel 70 has a confluence 73 that is provided at a downstream end of the right branch channel 72 and merges with the main channel 60. More specifically, the confluence 73 merges with the inner main channel 63 of the main channel 60. Since the branch channel 70 merges with the inner main channel 63, a flow path structure can be simplified.

As described above, the water jacket 50 has the branch 56, and the refrigerant flow path 55 of the water jacket 50 branches into the main channel 60 that adjusts a temperature of the terminal region A1 of each battery module 30 and the branch channel 70 that adjusts a temperature of the central region A2 of each battery module 30. Therefore, since the temperature of the terminal region A1 and the temperature of the central region A2 in each battery module 30 are adjusted in separate flow paths, the temperature of each battery module 30 can be effectively adjusted.

Further, since the refrigerant flows through the main channel 60 in order of the right battery module group 30R and the left battery module group 30L, and the refrigerant flows through the branch channel 70 in order of the left battery module group 30L and the right battery module group 30R, the refrigerant flowing through the main channel 60 and the refrigerant flowing through the branch channel 70 form a counter flow. Therefore, variations in temperature between the right battery module group 30R and the left battery module group 30L are reduced, and the temperatures of the plurality of battery modules 30 can be made close to uniform.

With the battery pack 1, it is possible to reduce variations in temperature among the plurality of battery modules 30 and to improve the temperature adjustment performance of the battery modules 30. As a result, it is possible to improve the performance of the battery modules 30 and prevent deterioration thereof.

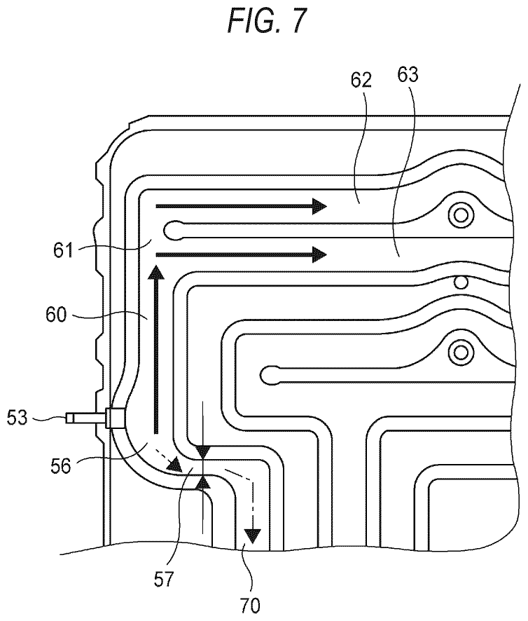

FIG. 7 is an enlarged top view of the branch 56. The branch 56 is provided with a throttle structure 57 that reduces a flow rate of the refrigerant flowing into the branch channel 70. The throttle structure 57 makes a flow rate difference between the refrigerant flowing through the main channel 60 and the refrigerant flowing through the branch channel 70.

Specifically, the throttle structure 57 has a function of reducing the flow rate of the refrigerant flowing into the branch channel 70 and adjusting a flow rate of the refrigerant flowing into the main channel 60 to be larger than that of the branch channel 70.

The throttle structure 57 has a structure that reduces a flow path width at a connection portion between the branch 56 and the branch channel 70 compared to a flow path width at a connection portion between the branch 56 and the main channel 60. Specifically, the throttle structure 57 is configured by reducing a flow path width in a horizontal direction and/or reducing a flow path width in a vertical direction. More specifically, the throttle structure 57 is configured by reducing the width and height of the above-described irregularities formed on the cover plate 51 and/or the lower surface 13b of the case body 11, that is, is integrally formed on the cover plate 51 and/or the lower surface 13b of the case body 11.

By providing the throttle structure 57, the flow rate of the refrigerant flowing through the main channel 60 is larger than that of the branch channel 70. As described above, since the terminal region A1 of each battery module 30 is a portion corresponding to the terminal 33 of each battery cell 31, each terminal 33 can be efficiently cooled by the main channel 60 having a large flow rate. In other words, since the terminal region A1 is a region having a large heat generation amount in each battery module, the region having a large heat generation amount in each battery module 30 can be efficiently cooled by the main channel 60 having a large flow rate.

The throttle structure 57 may be provided in the branch 61 of the main channel 60. The throttle structure 57 provided in the branch 61 can adjust the flow rate to make a flow rate difference between the refrigerant flowing through the outer main channel 62 and the refrigerant flowing through the inner main channel 63, or adjust the flow rate to make flow rates thereof equal.

Returning to FIG. 5, fins 58 extending along the flow direction of the refrigerant are provided in the refrigerant flow path 55 of the water jacket 50. The fins 58 are erected from the lower surface 13b of the case body 11 or the cover plate 51, and are formed integrally with the lower surface 13b of the case body 11 or the cover plate 51. In FIG. 6, the fins 58 are not illustrated.

The fins 58 are preferably provided in portions of the refrigerant flow path 55 where the refrigerant tends to accumulate and become stagnant. Specifically, the fins 58 are provided in corner regions 66 of the refrigerant flow path 55 and a confluence where the branched flow paths merge (for example, the confluence 64 of the branched outer main channel 62 and inner main channel 63). Each of the corner regions 66 is, for example, a region including a portion where the flow path is bent at a substantially right angle or a portion where the flow path is bent at an acute angle, in which the refrigerant may accumulate and become stagnant. The corner region 66 may include a portion where the flow path is bent at an obtuse angle, provided these is a portion where stagnation occurs.

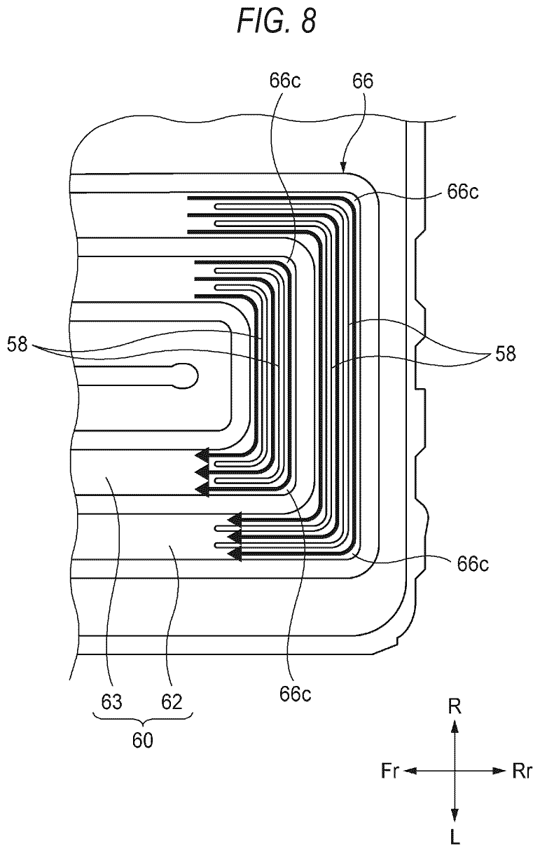

In the example illustrated in FIG. 5, the fins 58 are provided in the corner regions 66 at rear ends on both left and right sides of the main channel 60 (the outer main channel 62 and the inner main channel 63), the corner region 66 at a front end on the left side of the main channel 60 (the outer main channel 62 and the inner main channel 63), and the confluence 64. 51 FIG. 8 is an enlarged top view of the corner region 66 at a rear end of the main channel 60. Hereinafter, a detailed structure of the fin 58 provided in the corner region 66 at the rear end of the main channel 60 will be described with reference to FIG. 8, but the fin 58 provided in the corner region 66 at the front end on the left side of the main channel 60 and the fin 58 provided in the confluence 64 also have the same structure, and thus the descriptions thereof will be omitted.

When the fin 58 is not provided, stagnation may occur in a corner end 66c which is a portion of the corner region 66 where the flow path is bent at a substantially right angle. In the present embodiment, the fins 58 extending along the flow direction of the refrigerant are provided in the corner regions 66 of the outer main channel 62 and the inner main channel 63. The fin 58 is continuously provided across two adjacent corner regions 66, and extends in a substantially U shape when viewed from above.

Since the fin 58 is provided in the corner region 66, it is possible to prevent the refrigerant flow from stagnating at the corner end 66c. In other words, since the fin 58 functions as a rectifying plate and can allow the refrigerant to flow smoothly, as a result, the adjustment efficiency of the temperature of the battery module 30 can be improved.

A plurality of fins 58 are provided in parallel in each corner region 66. Here, two fins 58 are provided in parallel in each corner region 66. Accordingly, it is possible to further prevent stagnation from occurring at the corner end 66c.

The fin 58 is provided in the main channel 60 of the main channel 60 and the branch channel 70. As described above, since the main channel 60 has a large flow rate and a large flow velocity, stagnation is likely to occur at the corner end 66c. Therefore, by providing the fin 58 in the corner region 66 of the main channel 60, it is easy to obtain an effect of preventing the occurrence of stagnation.

The fin 58 is not limited to the positions illustrated in FIG. 5, and may be provided in any corner region and/or any confluence provided in the refrigerant flow path 55. The fin 58 may be provided in a corner region of the branch channel 70. Specifically, the fin 58 may be provided in another corner region or another confluence (for example, the confluence 73) provided in the refrigerant flow path 55.

When the fin 58 is provided in the confluence 64 or the confluence 73, a downstream end of the fin 58 preferably extends in the flow direction of the merged refrigerant. Accordingly, the merged refrigerant can flow smoothly, and the occurrence of stagnation at the confluence can be prevented.

The fin 58 may be provided in a region other than the corner region and/or the confluence, and may be provided, for example, along a flow path extending linearly.

### Modification

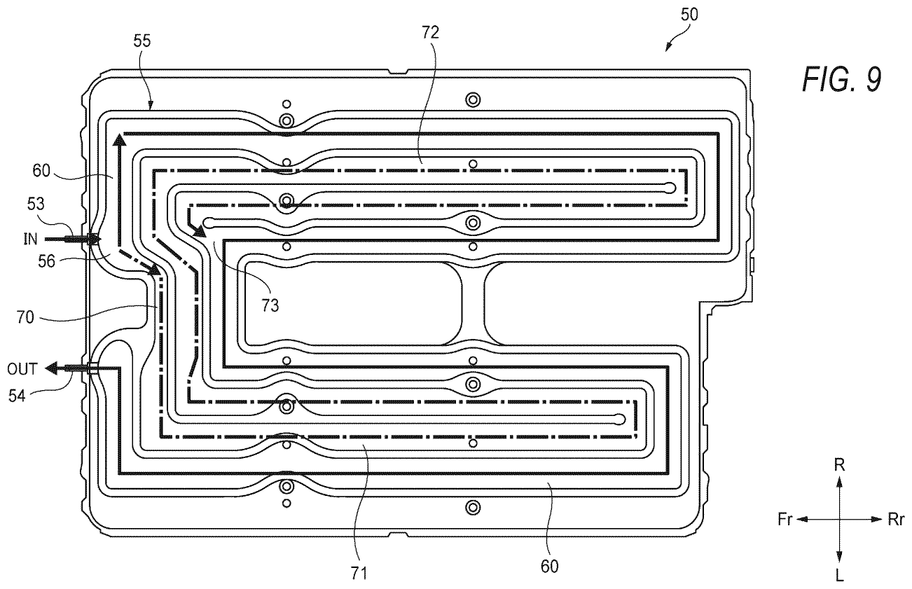

FIG. 9 is a top view of the water jacket 50 according to a modification. The water jacket 50 according to the modification does not have the branch 61 of the main channel 60. That is, the main channel 60 includes one flow path provided along the terminal region A1 of each battery module 30, and the refrigerant flows through the main channel 60 without branching from the branch 56 to the outlet 54. Similarly to the above-described embodiment, the branch channel 70 includes the left branch channel 71 and the right branch channel 72, and merges with the main channel 60 at the confluence 73 at the downstream end of the right branch channel 72. The branch channel 70 is provided along the central region A2 of each battery module 30, and the refrigerant flows therethrough.

Also in the water jacket 50 according to the modification, the refrigerant flows through the main channel 60 in order of the right battery module group 30R and the left battery module group 30L, and the refrigerant flows through the branch channel 70 in order of the left battery module group 30L and the right battery module group 30R. That is, the refrigerant flowing through the main channel 60 and the refrigerant flowing through the branch channel 70 form a counter flow.

Although not illustrated, it is preferable that the fins 58 extending along the flow direction of the refrigerant are also provided in the refrigerant flow path 55 of the water jacket 50 according to the modification. The configuration of the fins 58 is the same as the configuration described above, and the description thereof will be omitted.

With the water jacket 50 of such a modification, the same effects as those of the water jacket 50 described above can be achieved.

### Second Embodiment

Next, a battery pack 2 of a second embodiment will be described. In the following description, the same reference numerals are used for the same configurations as those of the battery pack 1 of the first embodiment, and thus the descriptions of the first embodiment may be incorporated.

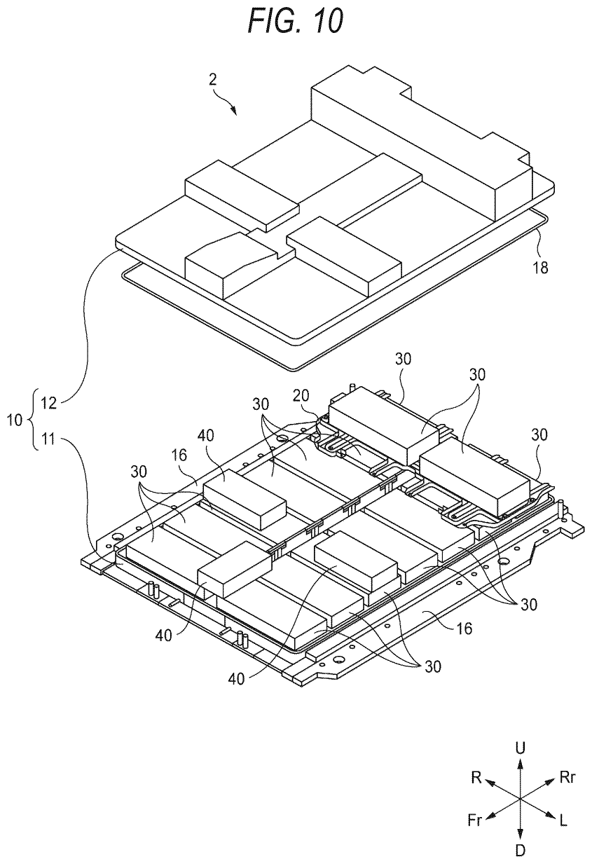

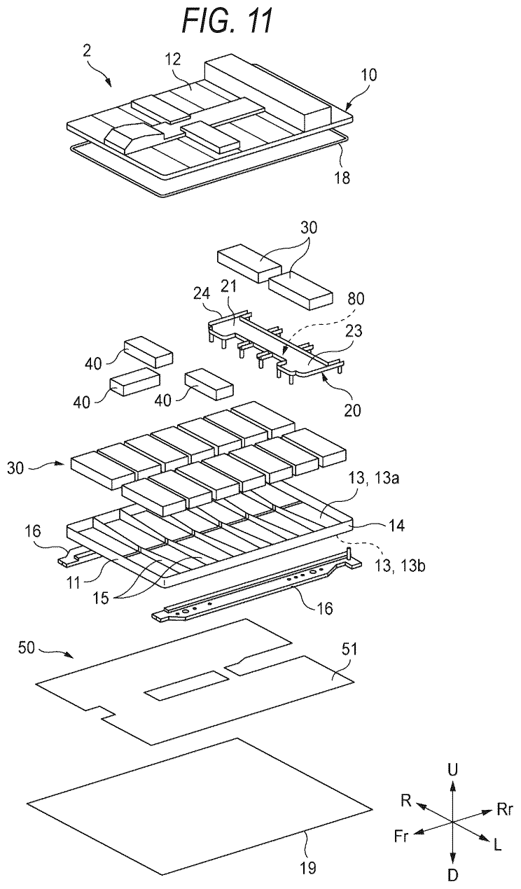

FIG. 10 is a perspective view of the battery pack 2 according to the second embodiment, illustrating a state in which the case cover 12 is removed from the case body 11. FIG. 11 is an exploded perspective view of the battery pack 2.

Similarly to the battery pack 1 of the first embodiment, the battery pack 2 is attached to an electric vehicle such as a battery type electric automobile, a plug-in hybrid vehicle, or a fuel cell vehicle, and stores power to be supplied to a motor or the like serving as a drive source of the electric vehicle. The battery pack 2 is attached under a floor of the electric vehicle. The battery pack 2 includes the battery case 10, a plurality of battery modules 30, the electric connection box 40, the water jacket 50, and the undercover 19.

The battery pack 2 further includes an upper-stage case body 20 that is provided above the battery modules 30 accommodated in the case body 11 and accommodates the battery modules 30, and an upper-stage water jacket 80 that is provided on a bottom portion 23 of the upper-stage case body 20 and through which a refrigerant for adjusting the temperature of the battery modules 30 flows. The battery pack 2 is configured by stacking the battery modules 30 in two stages in an upper-lower direction. In the description of the second embodiment, the battery modules 30 accommodated in the case body 11 may also be referred to as a lower-stage battery module 30, and the battery modules 30 accommodated in the upper-stage case body 20 may also be referred to as an upper-stage battery module 30.

The battery pack 2 has a larger number of battery modules 30 than the battery pack 1 of the first embodiment, and is configured as a battery pack having a larger capacity than the battery pack 1. Accordingly, an electric vehicle equipped with the battery pack 2 can achieve a longer cruising distance than an electric vehicle equipped with the battery pack 1.

The battery case 10 of the battery pack 2 includes the case body 11, the upper-stage case body 20, and the case cover 12. The configuration of the case body 11 of the second embodiment is basically the same as that of the first embodiment, but is different from that of the first embodiment in that seven battery modules 30 are aligned in the front-rear direction in each of left and right rows, and a total of 14 battery modules 30 are accommodated in the case body 11. The battery cells 31 of each battery module 30 are stacked in the front-rear direction.

The upper-stage case body 20 is provided at a rear end of the case body 11. Specifically, a part of the upper-stage case body 20 is disposed to overlap the lower-stage battery module 30 disposed in a rearmost row when viewed from above, and is provided in contact with or slightly spaced apart from an upper surface of the battery module 30. The upper-stage case body 20 accommodates two battery modules 30 aligned in the left-right direction.

The case cover 12 covers the case body 11 to which the upper-stage case body 20 is attached from above via the sealing material 18. Specifically, the case cover 12 covers both the case body 11 and the upper-stage case body 20 from above so as to face upper surfaces of the battery modules 30 accommodated in the case body 11 and upper surfaces of the battery modules 30 accommodated in the upper-stage case body 20. A portion of the case cover 12 that covers the battery modules 30 accommodated in the upper-stage case body 20 protrudes upward. The case cover 12 covers the case body 11 from above via the sealing material 18, thereby sealing the inside of the battery case 10. In this way, since the case body 11 and the upper-stage case body 20 are covered from above by the common case cover 12, a height dimension and weight of the battery pack can be reduced as compared with a case where separate case covers are provided for the case body 11 and the upper-stage case body 20, respectively.

Three electric connection boxes 40 of the battery pack 2 are provided, one of which is provided near a front end of the battery pack 2, and two of which are provided in a central portion in the front-rear direction. The three electric connection boxes 40 are accommodated in the case body 11 and are provided further forward than the upper-stage case body 20.

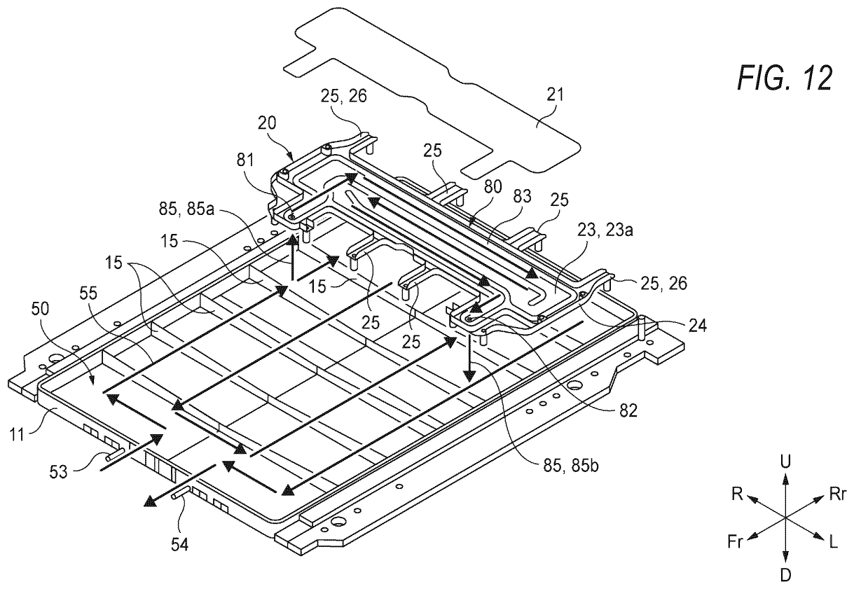

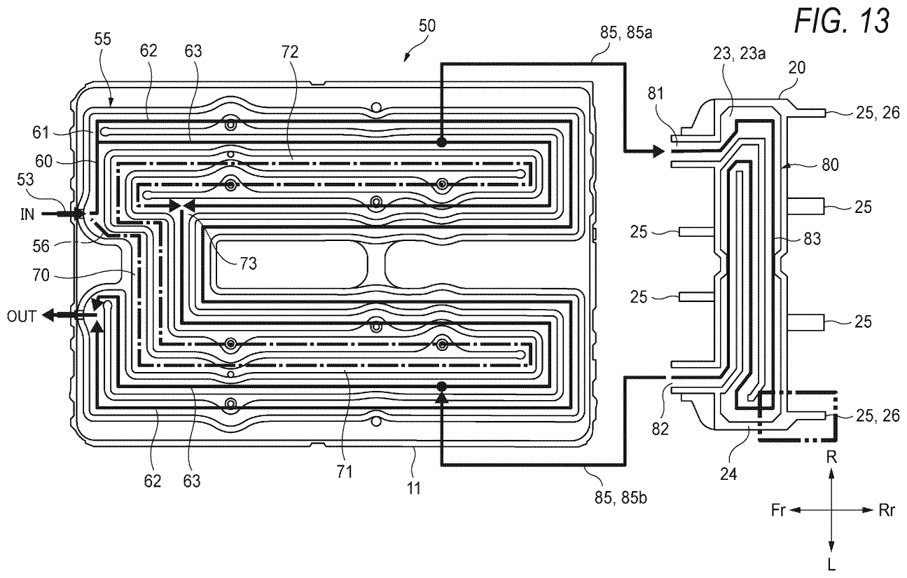

FIG. 12 is a perspective view of the upper-stage case body 20, the water jacket 50, and the upper-stage water jacket 80. In FIG. 12, the branch channel 70 of the water jacket 50 is not illustrated. FIG. 13 illustrates flow paths of refrigerants in the water jacket 50 and the upper-stage water jacket 80.

The water jacket 50 provided in the bottom portion 13 of the lower-stage case body 11 has the same configuration as that of the first embodiment. That is, the refrigerant flows through the main channel 60 in order of the right battery module group 30R and the left battery module group 30L, and the refrigerant flows through the branch channel 70 in order of the left battery module group 30L and the right battery module group 30R. That is, the refrigerant flowing through the main channel 60 and the refrigerant flowing through the branch channel 70 form a counter flow. The water jacket 50 of the second embodiment may have the same configuration as that of the modification of the first embodiment.

Although not illustrated, it is preferable that the fins 58 extending along the flow direction of the refrigerant are also provided in the refrigerant flow path 55 of the water jacket 50 of the second embodiment.

The upper-stage case body 20 includes a bottom portion 23 and an erect wall 24 erected around the bottom portion 23, and is formed in a tray shape. The upper-stage case body 20 is provided with a plate member 21 that seals and covers an upper surface 23a of the bottom portion 23 from above. The two battery modules 30 are placed side by side in the left-right direction on the plate member 21. Each battery module 30 is placed on the plate member 21 such that the battery cells 31 are stacked in the front-rear direction.

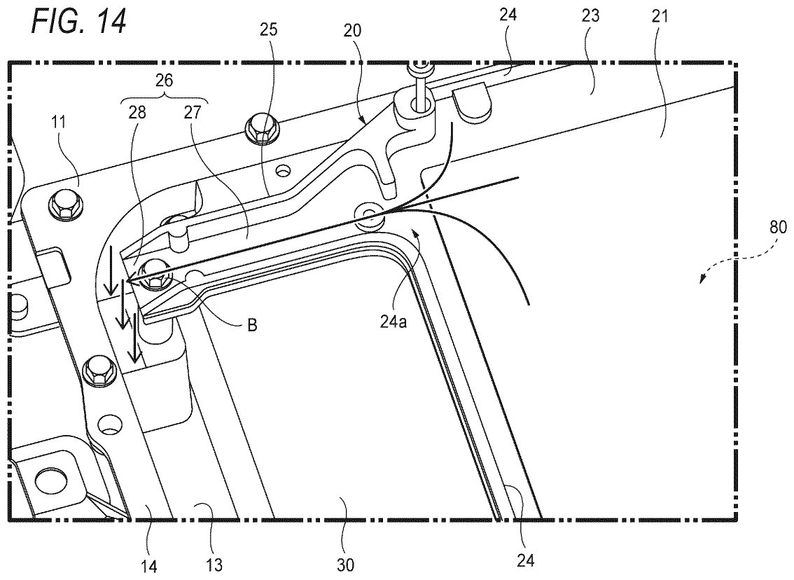

The upper-stage case body 20 includes a plurality of case fixing portions 25. Each case fixing portion 25 extends toward an outer periphery of the upper-stage case body 20. Each case fixing portion 25 is provided with a bolt insertion hole penetrating in the upper-lower direction, and a fastening member B (see FIG. 14) such as a bolt is inserted into the bolt insertion hole and fastened to the case body 11, so that the upper-stage case body 20 is fixed to the case body 11. A fixing portion on the case body 11 side is provided at a portion with high rigidity such as the side wall 14 or the cross member 15.

The upper-stage water jacket 80 is provided in a space defined between the upper surface 23a of the bottom portion 23 of the upper-stage case body 20 and the plate member 21. Specifically, in the upper-stage case body 20, a groove constituting a refrigerant flow path 83 is formed on the upper surface 23a, and the plate member 21 covers the groove to define the upper-stage water jacket 80. The plate member 21 is joined to the upper-stage case body 20 by welding, for example. The groove constituting the refrigerant flow path 83 may be formed in the plate member 21.

The upper-stage water jacket 80 is provided on the upper surface 23a side of the bottom portion 23 of the upper-stage case body 20, and has a configuration different from that of the water jacket 50 provided on the lower surface 13b side of the bottom portion 13 of the case body 11. With the water jacket 50 and the upper-stage water jacket 80, even when the cover plate 51 or the plate member 21 is damaged due to a collision of the electric vehicle or the like and the refrigerant leaks from the water jacket 50 and/or the upper-stage water jacket 80, it is possible to ensure waterproof performance for the lower-stage battery module 30 accommodated in the case body 11.

The upper-stage water jacket 80 is provided to communicate with the water jacket 50. The refrigerant flowing through the water jacket 50 branches and flows into the upper-stage water jacket 80, and the refrigerant flowing through the upper-stage water jacket 80 merges back into the water jacket 50. An inlet 81 of the upper-stage water jacket 80 is provided on a right front side of the upper-stage water jacket 80, and the outlet 82 is provided on a left front side of the upper-stage water jacket 80.

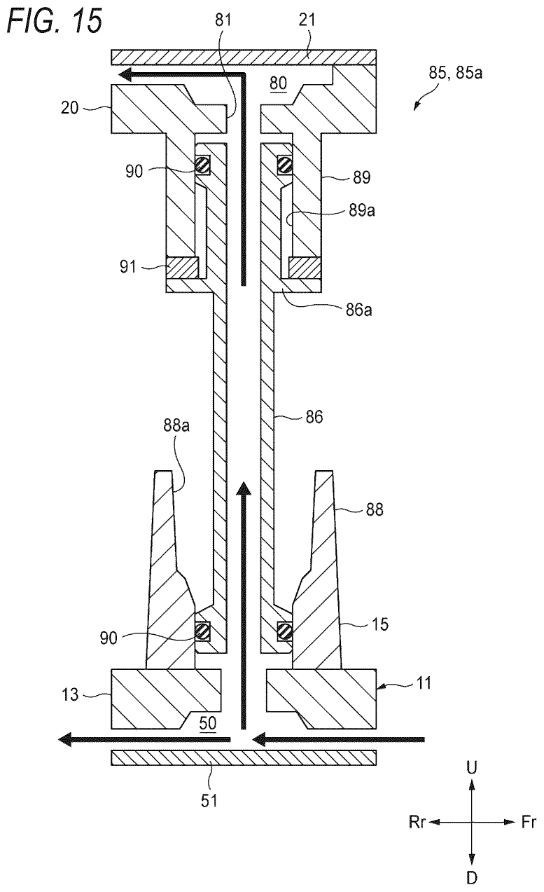

An inflow-side communication flow path 85a connecting the water jacket 50 and the inlet 81 of the upper-stage water jacket 80 and an outflow-side communication flow path 85b connecting the water jacket 50 and the outlet 82 of the upper-stage water jacket 80 are constituted by a pipe member 86 extending in the upper-lower direction (see FIG. 15). The inflow-side communication flow path 85a and the outflow-side communication flow path 85b are provided inward than the left and right side walls 14 of the case body 11 in the left-right direction.

The inflow-side communication flow path 85a is connected to an upstream side of the main channel 60 of the water jacket 50, and the refrigerant flowing through the main channel 60 branches and flows into the upper-stage water jacket 80. The outflow-side communication flow path 85b is connected to a downstream side of the main channel 60 of the water jacket 50, and the refrigerant flowing through the upper-stage water jacket 80 merges into the water jacket 50. In the illustrated example, the inflow-side communication flow path 85a and the outflow-side communication flow path 85b are connected to the inner main channel 63 of the water jacket 50, but may be connected to the outer main channel 62. In the following description, when the inflow-side communication flow path 85a and the outflow-side communication flow path 85b are not distinguished from each other, the inflow-side communication flow path 85a and the outflow-side communication flow path 85b may be collectively referred to as a communication flow path 85.

The communication flow path 85 is disposed at a position overlapping the cross member 15 when viewed from above. Since the communication flow path 85 is disposed in the cross member 15 with high rigidity, for example, even when an external impact is input to the battery pack 2, damage to the communication flow path 85 can be prevented.

The refrigerant flow path 83 of the upper-stage water jacket 80 extends in the left-right direction while repeatedly turning back, and is formed in a serpentine shape from the inlet 81 to the outlet 82. Specifically, the refrigerant flowing in from the inlet 81 flows from the right side to the left side of the upper-stage water jacket 80, then turns back and flows from the left side to the right side, again flows from the right side to the left side, and flows out from the outlet 82 to the water jacket 50. With such a configuration, it is possible to reduce variations in temperature of the two battery modules 30 accommodated in the upper-stage case body 20.

The upper-stage water jacket 80 may also be provided with the fin 58 extending along the flow direction of the refrigerant described above.

FIG. 14 is an enlarged perspective view of a portion surrounded by a two-dot chain line in FIG. 13. The portion surrounded by a two-dot chain line is a portion including the case fixing portion 25 provided on a left rear side of the upper-stage case body 20.

The erect wall 24 of the upper-stage case body 20 is erected around the upper-stage water jacket 80, specifically, around the plate member 21, and constitutes a side wall of the upper-stage case body 20 having a tray shape. When the plate member 21 is damaged due to a collision of the electric vehicle or the like, the refrigerant may leak from the upper-stage water jacket 80. The erect wall 24 is configured to receive the leaked refrigerant. With such a configuration, it is possible to prevent the refrigerant from contacting the lower-stage battery module 30.

Further, the upper-stage case body 20 is provided with a discharge unit 26 that discharges the refrigerant leaking from the upper-stage water jacket 80 to a specific position of the case body 11. The thick solid arrows in FIG. 14 indicate a state in which the refrigerant leaking from the upper-stage water jacket 80 is discharged from the discharge unit 26. Since the upper-stage case body 20 is provided with the discharge unit 26, the refrigerant is prevented from accumulating in the upper-stage case body 20, and the accumulated refrigerant can be prevented from scattering and contacting the battery module 30 below.

The specific position of the case body 11 is, for example, a position different from the lower-stage battery module 30 accommodated in the case body 11. Accordingly, it is possible to reliably prevent the refrigerant discharged from the discharge unit 26 from contacting the battery module 30 below. Note that the specific position of the case body 11 does not necessarily have to be a position different from the lower-stage battery module 30, and for example, when a part of the lower-stage battery module 30 is covered with a member having a waterproof function such as a plate member, the discharge unit 26 may discharge the refrigerant to the position of the lower-stage battery module 30.

The discharge unit 26 includes a discharge path 27 extending from a notch 24a provided in the erect wall 24, and a discharge port 28 provided in the discharge path 27 and opened at a position not overlapping the lower-stage battery module 30 when viewed from above.

Since the notch 24a is provided in the erect wall 24, the refrigerant leaking from the upper-stage water jacket 80 can be guided to the discharge path 27. The notch 24a is formed from an upper end to a lower end of the erect wall 24, and the leaked refrigerant is smoothly guided to the discharge path 27.

The discharge port 28 is opened to a space between the lower-stage battery module 30 disposed in the rearmost row and the side wall 14 of the case body 11, and discharges the leaked refrigerant into the space. With such a configuration, the discharge unit 26 can guide the refrigerant leaking from the upper-stage water jacket 80 to the discharge port 28 through the discharge path 27 and reliably discharge the refrigerant from the discharge port 28 to a position where the refrigerant does not contact the lower-stage battery module 30.

The discharge unit 26 is provided integrally with the case fixing portion 25. Specifically, the discharge path 27 is formed in a portion of the case fixing portion 25 extending toward the outer periphery of the upper-stage case body 20, and the discharge port 28 is formed near the bolt insertion hole of the case fixing portion 25. Since the discharge unit 26 is provided integrally with the case fixing portion 25, the discharge unit 26 is provided in a portion with high rigidity, and damage to the discharge unit 26 due to an external impact can be prevented. In addition, a size of the upper-stage case body 20 can be reduced as compared with a case where the discharge unit 26 is provided separately from the case fixing portion 25.

It is preferable that the discharge unit 26 is provided in some case fixing portions 25 among the plurality of case fixing portions 25 and is not provided in the other case fixing portions 25. In the illustrated example, the discharge unit 26 is provided only in the case fixing portions 25 provided on the left rear side and the right rear side among the plurality of case fixing portions 25. In the case fixing portion 25 in which the discharge unit 26 is not provided, the notch 24a is not formed and the erect wall 24 extends, so that the rigidity of the upper-stage case body 20 can be ensured. In this way, by adopting a configuration in which the discharge unit 26 is provided in some case fixing portions 25 and the discharge unit 26 is not provided in the other case fixing portions 25, it is possible to discharge the leaked refrigerant while ensuring the rigidity of the upper-stage case body 20.

FIG. 15 is a cross-sectional view of the communication flow path 85 that allows the water jacket 50 to communicate with the upper-stage water jacket 80. The thick arrows in FIG. 15 indicate the flow of the refrigerant. Here, the inflow-side communication flow path 85a is illustrated as the communication flow path 85, but the outflow-side communication flow path 85b also has the same configuration except for the flow direction of the refrigerant.

The communication flow path 85 is constituted by the pipe member 86 extending in the upper-lower direction. The pipe member 86 is connected to a lower connection portion 88 provided in the water jacket 50 and an upper connection portion 89 provided in the upper-stage water jacket 80.

The lower connection portion 88 has an insertion hole 88a through which the pipe member 86 is inserted. Specifically, the insertion hole 88a is formed in the bottom portion 13 and the cross member 15 of the case body 11, and is a tubular hole that supports a lower end of the inserted pipe member 86. An O-ring 90 is provided on an outer periphery of the lower end of the pipe member 86, and the lower end of the pipe member 86 is connected to the lower connection portion 88 via the O-ring 90 in a liquid-tight manner.

The upper connection portion 89 has an insertion hole 89a through which the pipe member 86 is inserted. Specifically, the insertion hole 89a is formed in the upper-stage case body 20 at a position of the inlet 81 of the upper-stage water jacket 80, and is a tubular hole that supports an upper end of the inserted pipe member 86. The O-ring 90 is provided on an outer periphery of the upper end of the pipe member 86, and the upper end of the pipe member 86 is connected to the upper connection portion 89 via the O-ring 90 in a liquid-tight manner.

A rubber mount 91, which is an example of an elastic member formed of rubber or the like, is provided on the outer periphery of the upper end of the pipe member 86. The rubber mount 91 is placed on an annular flange portion 86a formed on the outer periphery of the upper end of the pipe member 86. In a state in which the pipe member 86 is connected to the water jacket 50 and the upper-stage water jacket 80, the rubber mount 91 is pressed in the upper-lower direction and abuts against the lower end of the upper connection portion 89.

A reaction force of the rubber mount 91 in the upper-lower direction can restrict the movement of the pipe member 86 in the upper-lower direction, for example, when the refrigerant flows. In addition, for example, even when a torque for rotating the pipe member 86 is applied to the pipe member 86, the reaction force of the rubber mount 91 in the upper-lower direction can prevent the occurrence of axial deviation of the pipe member 86.

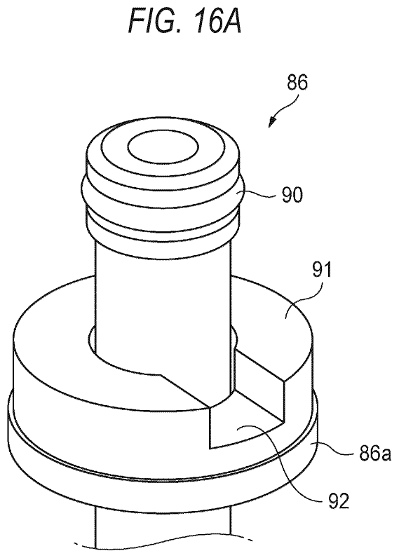

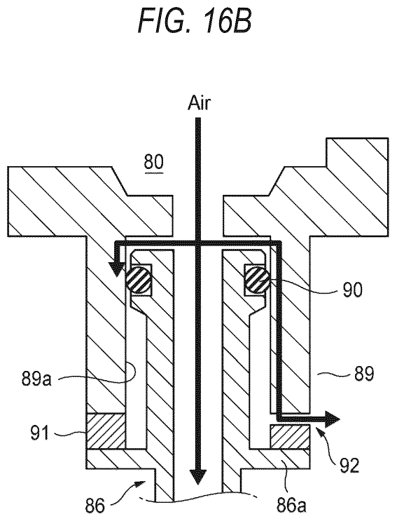

FIG. 16A is a perspective view of the upper end of the pipe member 86 provided with the rubber mount 91, and FIG. 16B is a cross-sectional view thereof.

The rubber mount 91 has a notch 92 provided in a portion (that is, an upper surface of the rubber mount 91) pressed against the upper connection portion 89 of the upper-stage water jacket 80. Since the notch 92 is provided, damage to the O-ring 90 can be inspected by injecting compressed air (thick arrows in FIG. 16B) into the pipe member 86 in a state of being connected to the upper-stage water jacket 80 during inspection after assembly of the battery pack 2. Specifically, as illustrated in FIG. 16B, when the O-ring 90 is damaged, the compressed air injected into the pipe member 86 flows out of the flow path through a damaged portion of the O-ring 90 and the notch 92 of the rubber mount 91.

Therefore, when the compressed air is injected into the pipe member 86 and the compressed air is detected near the rubber mount 91, it can be estimated that the O-ring 90 is damaged. With the configuration in which the notch 92 is provided, it is possible to provide the battery pack 2 in which the liquid tightness of the communication flow path 85 is sufficiently ensured.

Although embodiments and modifications of the present invention have been described above with reference to the accompanying drawings, it is needless to say that the present invention is not limited to the embodiments. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the embodiments described above, the plurality of battery cells 31 accommodated in the battery case 10 constitute the battery module 30 that is stacked and modularized, but may be stacked without modularization (that is, a cell laminate). Further, the battery cells 31 accommodated in the battery case 10 are not limited to the pouch-type cells or the rectangular cells described above, and may be cylindrical cells.

In addition, in the embodiments described above, the branches 56 and 61 divide the flow path into two channels, but the branches 56 and 61 may divide the flow path into three or more channels.

In the present specification, at least the following matters are described. In the parentheses, the corresponding constituent elements and the like in the above embodiment are shown as examples, but the present invention is not limited thereto.
(1) A battery pack (battery packs 1 and 2) including:
a plurality of battery cells (battery cells 31);
a battery case (battery case 10) accommodating the battery cells; and
a water jacket (water jacket 50) provided below the battery cells and having a flow path (refrigerant flow path 55) configured to allow a refrigerant for adjusting a temperature of the battery cells to flow therethrough, in which
the water jacket has a plurality of corner regions (corner regions 66) provided in the flow path, and
at least one of the corner regions is provided with a fin (fin 58) extending along a flow direction of the refrigerant.

According to (1), since the fin is provided in the corner region of the water jacket, the flow of the refrigerant is rectified, and the occurrence of stagnation in the corner region can be prevented. As a result, the temperature adjustment efficiency of the plurality of battery cells can be improved.
(2) The battery pack according to (1), in which
the plurality of battery cells are stacked and accommodated in the battery case,
the water jacket has a branch (branch 56) that branches into at least two flow paths from an inlet (inlet 53), and
the flow paths branched from the branch include a first flow path (main channel 60) provided along a first region (terminal region A1) of each battery cell and a second flow path (branch channel 70) provided along a second region (central region A2) different from the first region of each battery cell.

According to (2), since a temperature of the first region and a temperature of the second region in each battery cell are adjusted by separate flow paths (the first flow path and the second flow path), it is possible to effectively adjust the temperature of each battery cell.
(3) The battery pack according to (2), in which
a flow velocity of the refrigerant flowing through the first flow path is higher than a flow velocity of the refrigerant flowing through the second flow path, and
the fin is provided in the corner region of the first flow path.

According to (3), although the first flow path has a high flow velocity and is prone to stagnation in the corner region, the provision of the fin can prevent the occurrence of stagnation.
(4) The battery pack according to (2) or (3), in which
the fin is further provided at a confluence (confluence 73) where the first flow path and the second flow path merge.

According to (4), the flow of the refrigerant at the confluence can be rectified by providing the fin.
(5) The battery pack according to any one of (2) to (4), in which
the plurality of battery cells include a first cell group (right battery module group 30R) provided on one side in a predetermined direction and a second cell group (left battery module group 30L) provided on an other one side in the predetermined direction,
the refrigerant flows through the first flow path in order of the first cell group and the second cell group, and
the refrigerant flows through the second flow path in order of the second cell group and the first cell group.

According to (5), since the refrigerant flows through the first flow path in order of the first cell group and the second cell group, and the refrigerant flows through the second flow path branched from the inlet in order of the second cell group and the first cell group, the refrigerant flowing through the first flow path and the refrigerant flowing through the second flow path can form a counter flow, thereby reducing variations in temperature between the first cell group and the second cell group.
(6) A battery pack (battery packs 1 and 2) including:
a plurality of battery cells (battery cells 31);
a battery case (battery case 10) accommodating the battery cells; and
a water jacket (water jacket 50) provided below the battery cells and having a flow path (refrigerant flow path 55) configured to allow a refrigerant for adjusting a temperature of the battery cells to flow therethrough, in which
the water jacket has a confluence (confluence 64) where at least two flow paths merge, and
the confluence is provided with a fin (fin 58) extending along a flow direction of the refrigerant.

According to (6), since the fin is provided in the confluence of the water jacket, the flow of the refrigerant is rectified, and the occurrence of stagnation at the confluence can be prevented. As a result, the temperature adjustment efficiency of the plurality of battery cells can be improved.
(7) The battery pack according to (6), in which
the plurality of battery cells are stacked and accommodated in the battery case,
the water jacket has a branch (branch 56) that branches into at least two flow paths from an inlet (inlet 53), and
the flow paths branched from the branch include a first flow path (main channel 60) provided along a first region (terminal region A1) of each battery cell and a second flow path (branch channel 70) provided along a second region (central region A2) different from the first region of each battery cell.

According to (7), since a temperature of the first region and a temperature of the second region in each battery cell are adjusted by separate flow paths (the first flow path and the second flow path), it is possible to effectively adjust the temperature of each battery cell.
(8) The battery pack according to (7), in which
the water jacket further has another branch (branch 61) provided in the first flow path,
the first flow path includes a third flow path (outer main channel 62) and a fourth flow path (inner main channel 63) that are branched from the another branch and provided along the first region of each battery cell, and
the confluence provided with the fin includes a confluence (confluence 64) where the third flow path and the fourth flow path branched at the another branch merge.

According to (8), even when an object collides with a bottom surface of the battery pack and the third flow path (or the fourth flow path) of the water jacket is blocked, the flow of the refrigerant in the first flow path can be maintained through the fourth flow path (or the third flow path). Further, by providing the fin at the confluence of the third flow path and the fourth flow path, the flow of the refrigerant is rectified, and the occurrence of stagnation at the confluence can be prevented.
(9) The battery pack according to (7) or (8), in which
the confluence provided with the fin includes a confluence (confluence 73) where the first flow path and the second flow path merge.

According to (9), the flow of the refrigerant can be rectified by providing the fin at the confluence of the first flow path and the second flow path.
(10) The battery pack according to any one of (7) to (9), in which
the plurality of battery cells include a first cell group (right battery module group 30R) provided on one side in a predetermined direction and a second cell group (left battery module group 30L) provided on an other one side in the predetermined direction,
the refrigerant flows through the first flow path in order of the first cell group and the second cell group, and
the refrigerant flows through the second flow path in order of the second cell group and the first cell group.

According to (10), since the refrigerant flows through the first flow path in order of the first cell group and the second cell group, and the refrigerant flows through the second flow path branched from the inlet in order of the second cell group and the first cell group, the refrigerant flowing through the first flow path and the refrigerant flowing through the second flow path can form a counter flow, thereby reducing variations in temperature between the first cell group and the second cell group.

What is claimed is:

1. A battery pack comprising:
a plurality of battery cells;
a battery case accommodating the battery cells; and
a water jacket provided below the battery cells and having a flow path configured to allow a refrigerant for adjusting a temperature of the battery cells to flow therethrough, wherein
the water jacket has a plurality of corner regions provided in the flow path, and
at least one of the corner regions is provided with a fin extending along a flow direction of the refrigerant.

2. The battery pack according to claim 1, wherein
the plurality of battery cells are stacked and accommodated in the battery case,
the water jacket has a branch that branches into at least two flow paths from an inlet, and
the flow paths branched from the branch include a first flow path provided along a first region of each battery cell and a second flow path provided along a second region different from the first region of each battery cell.

3. The battery pack according to claim 2, wherein
a flow velocity of the refrigerant flowing through the first flow path is higher than a flow velocity of the refrigerant flowing through the second flow path, and
the fin is provided in the corner region of the first flow path.

4. The battery pack according to claim 2, wherein
the fin is further provided at a confluence where the first flow path and the second flow path merge.

5. The battery pack according to claim 2, wherein
the plurality of battery cells include a first cell group provided on one side in a predetermined direction and a second cell group provided on an other one side in the predetermined direction,
the refrigerant flows through the first flow path in order of the first cell group and the second cell group, and
the refrigerant flows through the second flow path in order of the second cell group and the first cell group.

6. A battery pack comprising:
a plurality of battery cells;
a battery case accommodating the battery cells; and
a water jacket provided below the battery cells and having a flow path configured to allow a refrigerant for adjusting a temperature of the battery cells to flow therethrough, wherein
the water jacket has a confluence where at least two flow paths merge, and
the confluence is provided with a fin extending along a flow direction of the refrigerant.

7. The battery pack according to claim 6, wherein
the plurality of battery cells are stacked and accommodated in the battery case,
the water jacket has a branch that branches into at least two flow paths from an inlet, and
the flow paths branched from the branch include a first flow path provided along a first region of each battery cell and a second flow path provided along a second region different from the first region of each battery cell.

8. The battery pack according to claim 7, wherein
the water jacket further has another branch provided in the first flow path,
the first flow path includes a third flow path and a fourth flow path that are branched from the another branch and provided along the first region of each battery cell, and
the confluence provided with the fin includes a confluence where the third flow path and the fourth flow path branched at the another branch merge.

9. The battery pack according to claim 7, wherein
the confluence provided with the fin includes a confluence where the first flow path and the second flow path merge.

10. The battery pack according to claim 7, wherein
the plurality of battery cells include a first cell group provided on one side in a predetermined direction and a second cell group provided on an other one side in the predetermined direction,
the refrigerant flows through the first flow path in order of the first cell group and the second cell group, and
the refrigerant flows through the second flow path in order of the second cell group and the first cell group.
